(19) United States
(12) Patent Application Publication
(10) Pub. No.: US 2001/0009831 A1
(43) Pub. Date: Jul. 26, 2001

(54) Antimicrobial wound coverings

(76) Inventors: Michael Schink, Hamburg (DE); Wolfgang Meyer-Ingold, Hamburg (DE); Michael Bogdahn, Buxtehude-Neukloster (DE); Norbert Ettner, Aichach (DE)

Correspondence Address: Norris McLaughlin & Marcus, P.A., 660 White Plains Road, Tarrytown, NY, 10591-5144, US

(21) Appl. No.: 09/728,858

(22) Filed: Dec. 1, 2000

(30) Foreign Application Priority Data
Dec. 3, 1999 (DE) 199 58 458.3

(51) Int. Cl. B32B 5/02; B32B 27/04; B32B 27/12; B32B 5/18

(52) U.S. Cl. 442/123; 442/394; 442/370; 442/371; 442/374; 442/375

(57) ABSTRACT

A wound covering comprising a synthetic polymer material comprising zeolites containing metal ions.

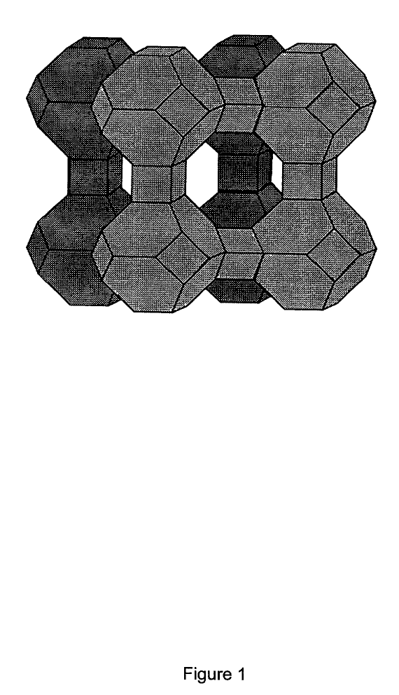

The invention relates to wound coverings which may be used to treat infected wounds or for preventive protection against wound infections.

The treatment and healing of bacterially contaminated or infected wounds is a great challenge to medicine and the natural sciences. Poorly healing wounds and chronic wounds in particular are often populated by a wide variety of microorganisms which greatly delay or sometimes even prevent entirely the course of healing. Even with acute wounds, however, caused by trauma, surgical intervention, or even just simple injury, the penetration of pathogenic microorganisms cannot be ruled out in every case.

As a result, the wound is colonized with microorganisms. A wound populated with more than 10⁵ CFU/g is referred to as an infected wound (M. C. Robson “Clinical Research can improve the outcome of treatment of problem wounds: Infection as a paradigm”, 8th Annual Meeting of the ETRS, Copenhagen, DK, Aug. 27-30, 1998). The massive colonization of the wound medium with microorganisms may result in a massive interference with the course of healing, which may lead ultimately to mortality. Frequent causative organisms of bacterial wound infections belong to the genera Pseudomonas, Staphylococcus, Clostridium and, among the yeasts and molds, to the genera Candida and Aspergillus. Limitation to a few species is impossible, since many of the microorganisms may be regarded as opportunistic pathogens.

A very wide variety of possibilities are described for removing microorganisms from the contaminated or infected tissue of a wound and/or for killing them therein. As well as by the oral administration of antibiotics, the removal of pathogenic microorganisms from a wound may be achieved, in accordance with the prior art, by the topical application of a disinfectant or an antibiotic. Furthermore, antiseptics and antibiotics are cytotoxic, and, moreover, many pathogenic strains have developed resistances to antibiotics. The fact that the development of resistance even to an antiseptic is possible has been reported for triclosan-resistant E. coli bacteria (McMurry L M et al (1998) FEMS Microbiol Lett 166(2): 305-9, Cookson B. D. et al (1991) Lancet 337 (8756): 1548-9; Uhl S (1993) Lancet 342(8865): 248). The principal critical factor in that case was the widespread and prophylactic use of triclosan (Irgasan®) in soaps, deodorants, textiles and plastics.

This shows that there is a need for new therapeutic forms for treating infected wounds.

Another possibility, albeit highly complex, is to clean the infected wound mechanically using sterile Ringer's solution or other liquids. A disadvantage that may be mentioned is that this operation has to be repeated at frequent intervals, which may delay the healing of the wound.

Ringer's solution, according to Römpp Lexikon Chemie (Version 1.5, Stuttgart/New York: Georg Thieme Verlag 1998), is an isotonic solution specified by the London pharmacologist S. Ringer (1835-1910) whose osmotic pressure is equal to that of normal blood (7.55 bar). The aqueous solution contains 0.8% sodium chloride, 0.02% potassium chloride, 0.02% calcium chloride and 0.1% sodium hydrogen carbonate. Ringer's solution contains these salts in approximately the same ratio as blood serum, which is why many cells can be kept alive in it for a relatively long period. It is used in particular as a blood substitute and infusion solution in cases of loss of electrolyte and water.

A well-known use, for example, for the antimicrobial and/or preventive therapy of contaminated or infected wounds is that of oxidants (for example iodine tincture) or antiseptics (for example, ointments containing silver sulfadiazine).

Another form in which such agents are used is that of correspondingly antimicrobially coated or impregnated wound coverings and woundcare materials. For instance, JP 03 083 905 describes fibers, films, papers and plastics comprising silver-containing phosphates which have bactericidal and fungicidal properties. A disadvantage in this case is that the wound subject to such treatment normally dries out. It is true that wound exudate constitutes an ideal nutrient medium for bacteria, and a reduction in the amount of wound exudate by means of moisture-absorbing wound coverings also gives rise to a reduction in the bacterial growth.

In addition to the application of antimicrobial preparations and the use of impregnated woundcare materials, the use of hydrophobicized backing materials is also described (EP 0 021 230 B1, EP 0 162 026 B1, EP 296 441 A1). In a hydrophilic medium (water, salt solution, wound fluid), hydrophobic bacteria are adsorbed by a wound covering which has been hydrophobicized by means of a complex chemical process. The bacteria are then removed from the wound by removal of the wound covering. A critical disadvantage here is that, in contrast to the common treatment methods set out above, bacteria and microorganisms are not killed. This disadvantage is intensified further if the treated wound dries out. This signifies the loss of the hydrophilic medium, which makes a critical contribution to the interaction between wound covering and bacteria. The bacteria and microorganisms, which have not been killed, detach from the wound covering and fall back into the wound bed.

In accordance with the prior art, it may be stated that dry wound treatment is obsolete.

The current requirements imposed on the function of modern, so-called interactive wound coverings go back to G. Winter (1962, Nature 193, 293) and have been reformulated by T. D. Turner (1994, Wound Rep. Reg. 2, 202). The primary requirement is to create a moisture wound medium, which in contrast to the traditional dry wound treatment such as by means of gauze compresses, for example, offers physiological—and hence better—conditions for the natural processes of wound healing.

A woundcare product modern in this sense is Arglaes®, a film dressing developed by Maersk Medical and possessing antimicrobial properties. The mechanism of action of Arglaes® is attributed to a new technology, called “Slow Release Polymer”, which within the moist medium of the wound brings about a slow but constant release of silver ions (Biomed. Mat. November 1995; Health Industry Today, Nov. 1, 1997, Vol. 58, No.11). Ultimately, however, this release also leads to direct contact of silver ions with wound tissue and thus to the risk of impairing even healthy cell growth during wound healing.

In Japan, zeolite particles have been developed which comprise silver ions. For instance, JP 60 181 002 reports natural and synthetic zeolites comprising silver, copper or zinc and exhibiting a long-lasting fungicidal activity. Such inorganic aluminosilicates become antibacterially or fungicidally active in the aqueous medium by means of an ion exchange mechanism with constant release of metal ions, and may be incorporated, for example, into fibers as an antibacterial ceramic powder bearing the designation Bactekiller®. These fibers have long been used in the household and sanitary sector in the form of air filters, wallpaper, carpets, cloths or the like. Particular mention should be made of zeolite particles comprising not only silver ions but also zinc ions. Zinc ions too, especially in combination with silver ions, have an antibacterial action (Keefer et al., Wounds 10 (1998) 54-58).

JP 10 120 518 describes antimicrobial compositions in the form of inorganic powders comprising metallic silver particles having a particle size of not more than 10 nm. Compositions of this kind, too, are aluminosilicates (zeolites), for example, which have an inclusion lattice, are notable for stability against staining and color change as a result of light, heat, pressure and chemical substances, and have a lasting antimicrobial activity.

JP 08 294 527 describes the production of polyvinyl alcohol-based wound coverings with antimicrobial active substances comprising silver, production taking place by the method of freeze drying from solution. The wound coverings exhibit good biocompatibility, moisture and oxygen permeability, and a long-lasting action.

JP 07 157 957 publicizes antibacterial polyurethane fibers and the production of antibacterial nonwovens by spinning from the melt. This process uses aromatic thermoplastic polyurethanes based on MDI-polytetramethylene glycol block copolymer and salts of phosphoric acid containing silver ions (Novaron AG-300).

The use of zeolites as the filler is specified, for example, in EP 0 057 839 B1.

U.S. Pat. No. 5,753,251 describes antimicrobial coatings which are produced on a medical product by deposition of metals, for example, silver, from the gas phase. The antimicrobial effect is based on the release of ions, atoms, molecules or clusters from a disrupted metal lattice assembly in contact with water- or alcohol-based electrolyte.

WO 91/11206 describes, for use as wound coverings, alginates containing cations from the group consisting of zinc, copper, silver, cerium, magnesium, cobalt, manganese, or iron. It gives no information about the release of the metal ions from the alginates or the mode of action.

WO 92/22285 also discloses alginates in combination with calcium compounds, magnesium compounds, zinc compounds or silver compounds, preferably silver sulfadiazine. The use of these alginates in wound healing is described. There is no description of whether there is controlled release of the metal ions from the alginates.

DE 196 31 421 A1 discloses the combination of a hydrophobic and thus bacteria-adsorbing material and of an antimicrobial active substance which is not released into the wound. This combination leads to a new mechanism of action with a synergetic effect. The wound covering acts as a barrier to microorganisms and it adsorbs the bacteria from the wound fluid. Following adsorption, these bacteria are killed on the wound covering, and the removal of the covering likewise removes the bacteria which have been killed plus unused active substance. Therefore, they no longer disrupt the course of healing. Suitable bacteria-adsorbing, hydrophobic materials may be synthetic or natural, or chemically modified natural, polymers, such as polyethylene, polypropylene, polyurethane, polyamide, polyester, polyvinyl chloride, polytetrafluoroethylene or polymers prepared by covalently bonding hydrophilic substances with hydrophobic groups, in accordance with EP 0 021 230 B1, for example. The bacteria-adsorbing properties of hydrophobic materials are known (cf. D. F. Gerson et al., Biochim. Biophys. Acta, 602 (1980, 506-510); Y. Fujioka-Hirai. et al., J. of Biochemical Materials Research, Vol. 21, 913-20 (1987); S. Hjerten et al., J. of Chromatography 101 (1974), 281-288; M. Fletcher et al., Appl. and Environmental Microbiology, January 1979, 67-72). The hydrophobic properties may also be demonstrated simply by a water drop test, in which the water runs off from the material in the form of a bead.

Suitable antimicrobial active substances, which is a reference primarily to substances known per se, such as chlorhexidine or phenol derivatives such as thymol and eugenol or the chlorodiphenyl ethers or chlorophenyls designated in DE 32 15 134 C2, for example, are notable for the fact that they adhere firmly to the wound covering, act on the microorganisms on or in said covering, and are not—or at least not markedly—released into the wound. This may take place by means of physical embedding or mounting on appropriate backings, for example, the embedding of hydrophobic active substances into hydrophobic backing materials, or else, for example, by covalent bonding to said materials. The active substance/backing systems should have the feature that even on multiple extraction with aqueous solutions or wound fluid they retain their antimicrobial activity. The wound coverings should comprise the antimicrobial active substance in an amount of at least 0.001% by weight in order to achieve sufficient activity.

The aim of the invention is to develop a wound covering which permits improved treatment of infected wounds and/or protection against infections and which does not have the disadvantages known from the prior art.

This object is achieved by a wound covering as set out in the main claim. The subclaims relate to advantageous developments of the wound covering.

The invention provides wound coverings having antimicrobial properties, wherein self-adhesive or nonself-adhesive materials used in wound healing, such as synthetic polymer materials, for example, polyurethanes, polyacrylates, SIBS compositions, SEBS compositions, natural rubber compositions and also chitosans, alginates, hydrogels, hydrocolloids, but especially polyurethanes, are combined with silver-containing zeolites which in preferred embodiments of the invention may be incorporated into the polymer materials at from 0.01 to 40% by weight, with particular preference from 0.1 to 6% by weight.

The designation zeolites was introduced by the Swedish mineralogist Cronstedt in 1756 and describes a widespread group of crystalline silicates, namely water-containing alkali metal and/or alkaline earth metal aluminosilicates (similar to the feldspars) of the general formula XM_{2/n} O Al₂O₃YSiO₂ZH₂O (M: mono-, di- or polyvalent metal ions such as, for example, Ag⁺, Na⁺, Zn²⁺ etc.; n: valence; X, Y, Z: partial molar amount, subject to the following guide values: Y=1.8 to about 12, Z=0 to about 8) (Source: Römpp Lexikon Chemie—Version 1.5, Stuttgart/New York: Georg Thieme Verlag 1998).

The crystal lattices of the zeolites are composed of SiO₄ and AlO₄ tetrahedra linked via oxygen bridges. The result is a three-dimensional arrangement of (adsorption) cavities of like construction which are accessible via windows (pore apertures) or channels, each of equal size. Depicted below is a synthetic zeolite A.

[chemical structure]

A crystal lattice of this kind is able to act, so to speak, as a sieve which accepts molecules having a smaller cross section than the pore openings in the cavities of the lattice, while larger molecules are unable to penetrate (so-called molecular sieves).

The cations needed to compensate the negative charge of the AlO₄ tetrahedra in the aluminosilicate structure are relatively mobile in the hydrated lattice and may readily be replaced by other metal ions, thus providing the ion exchange properties; in laundry detergents, for instance, the zeolites (especially zeolite A) reduce the hardness of the water since they remove the calcium ions from the water and the stains.

Another class of microporous solids is formed by the alumophosphates, silicoalumophosphates, and metalloalumophosphates.

The synthetic zeolites are classified in accordance with pore size (usually still in Angström units) as narrow, medium and wide pore types. Within this group there exist more than 150 different structures which may frequently be distinguished in terms of their SiO₂/Al₂O₃ ratio (known as the modulus).

In general, synthetic zeolites are given trivial names such as, for example, zeolite A, X, Y, L, b, inter alia, or else are designated as ZSM types, inter alia.

For the purpose of characterization, use is made, in particular, of X-ray diffractometry, solid-state NMR, FT-IR spectroscopy, thermoanalysis, electron microscopy, adsorption measurements and catalytic reactions.

In accordance with JP 60 181 002, the antibacterial zeolites are produced from natural or synthetic zeolite as backing and from at least one ion-exchangeable metal ion from the group consisting of silver, copper and zinc by substitution in water, for example, using an organic or inorganic binder. Following subsequent drying, the product is calcined at atmospheric or subatmospheric pressure in a range below the temperature at which the zeolite begins to decompose. The antibacterial zeolites comprise from 0.0006 to 4% silver, from 0.03 to 10% copper or from 0.04 to 14% zinc.

Deserving of particular emphasis in accordance with the invention is the novel use of the zeolites as part of a self-adhesive polyurethane matrix which may be used as a hydroactive wound covering for moist wound healing.

Preference is given to the use of elastic, crosslinked polyurethanes with a mass application rate of from 50 to 2500 g/m², as described, for example, in WO 97/43328 A1. The invention there provides hydrophilic, self-adhesive polyurethane gels of the following composition:

a) polyether polyols having 2 to 6 hydroxyl groups, OH numbers of from 20 to 112, and an ethylene oxide (EO) content of >=10% by weight,

b) antioxidants,

c) bismuth(III) carboxylates based on carboxylic acids having 2 to 18 carbon atoms as catalysts, which are soluble in the polyols a), and

d) hexamethylene diisocyanate or modified hexamethylene diisocyanate, featuring a product of the functionalities of the polyurethane-forming components a) and d) of at least 5.2, the amount of catalyst c) being from 0.005 to 0.25% by weight, based on the polyol a), the amount of antioxidant b) being in the range from 0.1 to 1.0% by weight, based on polyol a), and a ratio of free NCO groups of component d) to the free OH groups of component a) (isocyanate index) in the range from 0.30 to 0.70 being chosen.

Preference is given to the use of polyether polyols having 3 to 4, with very particular preference 4, hydroxyl groups, and an OH number in the range from 20 to 112, preferably from 30 to 56. The ethylene oxide content of the polyether polyols employed is preferably >=20% by weight.

The polyether polyols are known per se as such and are prepared, for example, by polymerizing epoxides, such as ethylene oxide, propylene oxide, butylene oxide or tetrahydrofuran, with themselves or by subjecting these epoxides, preferably ethylene oxide and propylene oxide, optionally as a mixture with one another or separately in succession, to addition reaction with starter components containing at least two reactive hydrogen atoms, such as water, ethylene glycol, propylene glycol, diethylene glycol, dipropylene glycol, glycerol, trimethylol propane, pentaerythritol, sorbitol or sucrose. Representatives of the abovementioned polyhydroxyl compounds of relatively high molecular mass which are to be used are set out, for example, in High Polymers, Vol. XVI, “Polyurethanes, Chemistry and Technology” (Saunders-Frisch, Interscience Publishers, New York, Vol. 1, 1962, pp. 32-42).

The isocyanate component used comprises monomeric or trimerized hexamethylene diisocyanate or hexamethylene diisocyanate modified by means of biuret, uretdione, allophanate groups or by prepolymerization with polyether polyols or mixtures of polyether polyols based on the known starter components containing 2 or >2 reactive H atoms and epoxides, such as ethylene oxide or propylene oxide, with an OH number of <=850, preferably from 100 to 600. Preference is given to the use of modified hexamethylene diisocyanate, especially hexamethylene diisocyanate modified by prepolymerization with polyether diols with an OH number of from 200 to 600. Very particular preference is given to modifications of hexamethylene diisocyanate with polyether diols with an OH number of from 200 to 600 whose residual monomeric hexamethylene diisocyanate content is below 0.5% by weight.

Antioxidants suitable for the polyurethane gels comprise, in particular, sterically hindered phenolic stabilizers, such as BHT (2,6-di-tert-butyl-4-methylphenol), Vulkanox BKF (2,2′-methylene-bis-(6-tert-butyl-4-methylphenol) (Bayer AG), Irganox 1010 (pentaerythrityl tetrakis[3-(3,5-di-tert-butyl-4-hydroxyphenyl)propionate]), Irganox 1076 (octadecyl 3-(3,5-di-tert-butyl-4-hydroxyphenyl)propionate) (Ciba-Geigy) or tocopherol (Vitamin E). It is preferred to use those of the a-tocopherol type. The antioxidants are used preferably in amounts from 0.15 to 0.5% by weight, based on the polyol a).

The polyurethane gel compositions are prepared by customary processes, as described, for example, in Becker/Braun, Kunststoff-Handbuch, Vol. 7, Polyurethane, p. 121 ff., Carl-Hanser, 1983.

Use is also made of elastic, thermoplastic polyurethanes, as described in DE-C 19 34 710, which are notable for good skin compatibility and also oxygen and water vapor permeability. Aliphatic polyester urethanes have proven particularly advantageous.

A wound covering produced therewith is preferably from about 30 to 40 μm in thickness, transparent, has an elongation at break of more than 450% and a water vapor permeability of more than 500 g/m² in 24 h at 38° C. and 95% rel. humidity in accordance with DAB [German Pharmacopeia]

In addition, however, it is also possible to use wound coverings on a different basis, such as, for example, acrylate copolymers or the other known film-forming elastic polymers.

The thickness of the wound coverings may be from about 15 to 300, preferably from 15 to 80 μm, the weight, accordingly, from about 15 to 350 g/m², preferably from 15 to 100 g/m², the longitudinal ultimate tensile strength from about 5 to 100 N/cm, preferably from 2 to 40 N/cm, and the longitudinal elongation at break from about 100 to 1000%.

It has surprisingly been found that the zeolites may be incorporated into polyurethanes by admixing the zeolite to the polyurethane base materials, without disrupting the reaction, and that they are able to develop their antimicrobial action despite incorporation into the polymer.

An additional possibility is the incorporation of superabsorbent powders, for example Favor® (Stockhausen), for the purpose of selective absorption of water.

Further applications arise through the foaming of the polyurethanes described. The unfoamed or foamed compositions may be spread out flat with different mass application rates and on the skin-remote side may optionally be lined with a film of, for example, polyethylene, polyurethane, polyester or film/nonwoven composite materials.

If desired, the wound covering is provided on the skin-facing side with a self-adhesive coating, which is preferably applied partially.

An appropriate adhesive composition is specified in the document DE 27 43 979 C3; additionally, standard commercial pressure-sensitive adhesive compositions based on acrylate or rubber may be used with preference for the adhesive coating.

Particular preference is given to thermoplastic hot-melt adhesive compositions based on natural and synthetic rubbers and other synthetic polymers such as acrylates, methacrylates, polyurethanes, polyolefins, polyvinyl derivatives, polyesters or silicones with corresponding additives such as tackifier resins, plasticizers, stabilizers and other auxiliaries where necessary.

If desired, subsequent crosslinking by irradiation with UV or electron beams may be appropriate.

Hot-melt adhesive compositions based on block copolymers, in particular, are notable for their diverse variation possibilities, since the controlled reduction in the glass transition temperature of the self-adhesive composition as a result of the selection of the tackifiers, the plasticizers, the polymer molecule size and the molecular distribution of the starting components ensures the required bonding to the skin in a manner appropriate to their function, even at critical points of the human locomotor system.

Their softening point should be higher than 50° C., since the application temperature is generally at least 90° C., preferably between 120° C. and 150° C., or 180° C. and 220° C. in the case of silicones.

The high shear strength of the hot-melt adhesive composition is achieved through the high cohesiveness of the polymer. The good finger tack results from the range of tackifiers and plasticizers used.

The adhesive composition preferably comprises at least one aromatic component, which has a fraction of less than 35%, preferably from 5 to 30%.

For systems which adhere particularly strongly, the hot-melt adhesive composition is based preferably on block copolymers, especially A-B or A-B-A block copolymers or mixtures thereof. The hard phase A is primarily polystyrene or its derivatives and the soft phase B comprises ethylene, propylene, butylene, butadiene, isoprene or mixtures thereof, particular preference being given here to ethylene and butylene or mixtures thereof.

The controlled blending of diblock and triblock copolymers is particularly advantageous, preference being given to a diblock copolymer fraction of less than 80% by weight. In one advantageous embodiment the hot-melt adhesive composition has the composition indicated below:

| | |
|---|---|
| from 10% by weight to 90% by weight of | block copolymers, |
| from 5% by weight to 80% by weight of | tackifiers such as oils, waxes, |
| | resins and/or mixtures thereof, |
| | preferably mixtures of resins |
| | and oils, |
| less than 60% by weight of | plasticizers, |
| less than 15% by weight of | additives, |
| less than 5% by weight of | stabilizers. |

The aliphatic or aromatic oils, waxes and resins used as tackifiers are preferably hydrocarbon oils, waxes and resins, with the consistency of the oils, such as paraffinic hydrocarbon oils, or the waxes, such as paraffinic hydrocarbon waxes, accounting for their favorable effect on bonding to the skin. Plasticizers used are medium- or long-chain fatty acids and/or their esters. These additions serve to adjust the adhesion properties and the stability. If desired, further stabilizers and other auxiliaries are employed.

Following application to an exuding wound, a wound covering comprising silver zeolite particles will by means of contact between fluid and the silver zeolite particles kill the microorganisms present in the wound fluid, and/or will prevent colonization and, in certain circumstances, infection of the wound with microorganisms. The antibacterial action is canceled with the removal of the wound covering comprising silver zeolite particles. Subsequent washing of the wound to remove antibiotics and antiseptics applied temporarily beforehand is unnecessary.

Preference is given to the use of zeolite particles which as well as releasing silver ions also comprise zinc ions. In this case, through the ion exchange action of the zeolite, small, defined amounts of silver ions and zinc ions are released in the moist medium, so guaranteeing a long-lasting antibacterial action.

The described invention is therefore based on the above-described antimicrobial action of silver-doped zeolite particles in combination with a strongly absorbent wound covering, which together achieve a synergetic effect. Furthermore, a wound covering, such as a polyurethane wound covering, for instance, may possess self-adhesive properties, which allow the covering to be affixed to the intact skin on the edge of the wound on the patient and which produce compliance. It relates to a novel wound covering which may be used to treat infected wounds or for preventive protection against wound infections. The wound covering forms a barrier to microorganisms, which prevents penetration from the outside by virtue of the fact that these microorganisms are killed on contact with the antimicrobial wound covering.

Wound coverings of the invention are described below in a preferred embodiment on the basis of a number of examples, without wishing thereby to restrict the invention in any way whatsoever. Additionally, a comparative example is given.

### EXAMPLES

The experiments described below are carried out using a zeolite comprising silver ions from the company Shinanen (commercial designation “Antimicrobial Zeomic”) having an average particle size of from 0.6 to 2.5 μm.

### Example 1 (Comparative)

29.8 g of Favor (partially neutralized polyacrylic acid from Stockhausen, Krefeld) were dispersed in 63.8 g of Levagel (polyether polyol from Bayer, Leverkusen) for one hour. The dispersion was subsequently mixed homogeneously with 6.2 g of Desmodur (hexamethylene diisocyanate-based polyisocyanate from Bayer, Leverkusen) and 0.50 g of Coscat 83 (bismuth salt from C. H. Erbslöh) and the still-liquid composition was spread out flat between a polyurethane backing (Beiersdorf, Hamburg) and a silicone paper, using a slot width of 1.2 mm. The crosslinking time of the polyurethane composition is 4 min 30 sec.

### Example 2

27.3 g of Favor were dispersed in 63.7 g of Levagel for one hour. The dispersion was subsequently mixed homogeneously with 5.7 g of Desmodur and 2.8 g of Zeomic (silver zinc zeolite containing approximately 2.2% silver and approximately 12.5% zinc, from Shinanen, Japan) and 0.5 g of Coscat 83 and the still-liquid composition was spread out flat between a polyurethane backing and a silicone paper, using a slot width of 1.2 mm. The crosslinking time of the polyurethane composition is 4 min 50 sec.

### Example 3

24.6 g of Favor were dispersed in 57.4 g of Levagel for one hour. The dispersion was subsequently mixed homogeneously with 5.1 g of Desmodur and 12.5 g of Zeomic and 0.4 g of Coscat 83 and the still-liquid composition was spread out flat between a polyurethane backing and a silicone paper, using a slot width of 1.2 mm. The crosslinking time of the polyurethane composition is 5 min.

### Example 4

87.1 g of Levagel, 8.5 g of Desmodur, 3.8 g of Zeomic and 0.6 g of Coscat 83 were mixed homogeneously and the still-liquid composition was spread out flat between a polyurethane backing and a silicone paper, using a slot width of 1.2 mm. The crosslinking time of the polyurethane composition is 4 min 30 sec.

### Investigations into the Antimicrobial Activity of Silver Zeolites

Bactericidal action of silver zeolites in the quantitative suspension test of DGHM* Borneff et al. (1981) Zbl. Bakt. Hyg. Series B: Vol. 172, No. 6

Description of the method:

Determination of the inactivating agent combination in accordance with DGHM (Deutsche Gesellschaft für Hygiene und Mikrobiologie [German Society of Hygiene and Microbiology]).

The microbicidal action of the silver zeolites is inactivated up to a concentration of

0.5% (w/v) by the combination TLHC (Tween 3%, lecithin 0.3%, histidine 0.1%, cysteine 0.1%).

Test procedure:

The test strains were cultured overnight in Caso or Sabouraud broth. 0.1 ml of these microorganism cultures was treated in each case in a sterile test tube with 10 ml of an aqueous 0.5% (w/v) silver zeolite suspension.

In parallel, for the purpose of determining a control value, 0.1 ml of the microorganism cultures was likewise treated with 10 ml of sterile, fully deionized water in each case in a further sterile test tube.

The exposure time of the test strains was 1 h at room temperature.

Following the exposure time, 1 ml of the silver zeolite/microorganism mixture was withdrawn and transferred to 9 ml of inactivating agent liquid. After a contact time of not more than 30 minutes in this solution, further geometric dilutions were prepared. To determine the microbe count, pour plates were prepared from appropriate dilutions, with incubation at 37° C. for from 48 h to 72 h.

The same procedure was followed with the control value in parallel with the sample. For each test microorganism, there were two resulting microbe counts:

1. CFU (sample=containing silver zeolite)

2. CFU (control)

(CFU=colony-forming unit)

The reduction factor (RF) for each test strain is calculated in accordance with the following formula:

log RF=log CFU (control)−log CFU (sample)

The reduction factors were determined from 3 quantitative suspension tests in accordance with DGHM.

| Test strain | | | RF |
|---|---|---|---|
| Number of the laboratory | RF | RF | (XXIV/S.45- |
| documentation | (X/S. 121-124/Ti) | (XXIII/S 76-79/Sch) | 48;51 + 52/Sch) |
| S.aureus ATCC 6538- | 1.38 | 1.78 | 1.48 |
| E.coli ATCC 11229 | 3.72 | 2.62 | 3.94 |
| Ps.Aeruginosa ATCC 15442 | 5.65 | 3.39 | 6.89 |
| Pr.mirabilis ATCC 14153 | — | 2.39 | 3.33 |
| C.albicans ATCC 10231 | 4.68 | 4.75 | 6.15 |

Key to the microorganisms
S.aureus = Staphylococcus aureus
E.coli = Escherichia coli
Ps.Aeruginosa = Pseudomonas aeruginosa
Pr.mirabilis = Proteus mirabilis
C.albicans = Candida albicans

Antimicrobial activity of various product specimens

Experimental setup:

The test strains were cultured overnight in Caso or Sabouraud broth. Following culturing, the test strains were centrifuged at 3500 rpm and washed twice with sterile, fully deionized water. The test strains were taken up again in sterile, fully deionized water,

The γ-sterilized test specimens were contaminated on the wound-facing side with 2×50 μl of the microbe suspension in each case and subsequently incubated in a moist chamber at 32° C. for 1 h.

Specimens without silver zeolite (Example 1) were used as the control.

Following the incubation period, the specimens were transferred to 100 ml of workup solution in which they stayed for 5 minutes for the purpose of swelling.

The specimens were subsequently treated in a Stomacher for 60 sec and the number of microorganisms capable of division was determined by means of a pour plate. Incubation: 48 h to 72 h, 32° C.

The reduction factor (RF) for each test strain is calculated in accordance with the following formula:

log RF=log CFU (control)−log CFU (Sample)

| | Ps. aeruginosa | C.albicans |
|---|---|---|
| Test specimen | ATCC 15442 | ATCC 10231 |
| Example 2 | 2.43 | 4.60 |
| 2.8% zeolite, 27.3% Favor | | (XXV/S.120-123/Sch) |
| Example 3 | 4.07 | 4.60 |
| 12.5% zeolite, 24.6% Favor | | (XXV/S.120-123/Sch) |

ATCC: American Type Culture Collection (Indication of the precise number of the test organism used)

What is claimed is:

1. A wound covering comprising a synthetic polymer material comprising zeolites containing metal ions.

2. The wound covering as claimed in claim 1, wherein said synthetic polymer material comprises said zeolites containing metal ions in an amount of from 0.01 to 40% by weight, preferably from 0.1 to 6% by weight.

3. The wound covering as claimed in claim 1, wherein said synthetic polymer material is selected from the group consisting of polyacrylates, SIBS compositions, SEBS compositions, natural rubber compositions, chitosans, alginates, hydrogels, hydrocolloids, especially polyurethanes.

4. The wound covering as claimed in claim 1, wherein said synthetic polymer material has been foamed.

5. The wound covering as claimed in claim 1, wherein said synthetic polymer material has been lined on the skin-remote side with a film and/or with a film/nonwoven composite material.

6. The wound covering as claimed in claim 1, further comprising superabsorbents.
